(19) United States
(12) Patent Application Publication
(10) Pub. No.: US 2018/0237316 A1
(43) Pub. Date: Aug. 23, 2018

(54) Reverse Osmosis Water Filters for Producing Water With Selectable Total Dissolved Solids

(71) Applicant: Topper Manufacturing Corporation, Torrance, CA (US)

(72) Inventor: Timothy Allen Beall, Redondo Beach, CA (US)

(21) Appl. No.: 15/895,154

(22) Filed: Feb. 13, 2018

Related U.S. Application Data
(60) Provisional application No. 62/460,638, filed on Feb. 17, 2017.

(51) Int. Cl. C02F 1/44; B01D 61/02; B01D 61/08; A47J 31/60

(52) U.S. Cl. CPC C02F 1/441; B01D 61/025; B01D 61/08; B01D 2313/24; C02F 2209/03; C02F 2209/40; A47J 31/605

(57) ABSTRACT

Methods and apparatus for providing water with a selectable total dissolved solids content. The apparatus includes a reverse osmosis filter system to provide filtered water having a dissolved solids content less than the selectable total dissolved solids content and for mixing water having a dissolved solids content exceeding the selectable total dissolved solids content with the filtered water in a ratio to provide water with the selectable total dissolved solids content. Various embodiments are disclosed.

### CROSS-REFERENCE TO RELATED APPLICATIONS

This application claims the benefit of U.S. Provisional Patent Application No. 62/460,638 filed Feb. 17, 2017, the entirety of which is incorporated herein by reference.

### BACKGROUND OF THE INVENTION

### 1. Field of the Invention

The present invention relates to the field of reverse osmosis water filter systems.

### 2. Prior Art

Reverse osmosis water filter systems are well known in the prior art. Many reverse osmosis filter systems use a product water storage tank in the form of a hydraulic accumulator wherein a flexible diaphragm separates the product water from a trapped quantity of compressible gas, sometimes referred to an air captive system. In this type of system, the gas pressure is relatively low when the accumulator does not contain product water and steadily increases as the accumulator accumulates product water, eventually stopping the production of product water as the gas pressure on one side of the diaphragm reaches the product water pressure on the other side of the diaphragm. Consequently in such systems, the rate of product water production is highest when the accumulator is empty of product water and steadily decreases as the accumulator is filling. Similarly in the dispensing of product water, the dispensing rate, which is controlled by the pressure of the compressible gas in the accumulator, is greatest when the accumulator is filled with product water and steadily diminishes during dispensing because of the decreasing gas pressure in the accumulator.

Another type of product water storage and dispensing for reverse osmosis water filter product water storage purposes is referred to herein as a squeeze water system. In such systems, the accumulator has a diaphragm similar to that hereinbefore described, with product water being stored on one side of the diaphragm. The other side of the diaphragm, however, does not restrain a compressible gas, but rather is filled with what is referred to herein as squeeze water, the pressure of which is preferably controlled through a control valve between a low pressure, which will allow product water to freely accumulate on one side of the diaphragm unrestrained by any changes in pressure on the other side during production of product water, and to be subjected to an elevated pressure which will cause the dispensing of the product water through a conveniently located faucet or other device.

The advantage of these latter systems is that the rate of product water production is maintained substantially at a constant rate because of the absence of any substantial pressure variation on the other side of the accumulator diaphragm throughout the product water production phase, and similarly the rate of dispensing of the product water remains constant, independent of the amount of product water in the storage tank because of the fixed squeeze water pressure throughout the dispensing cycle.

Reverse osmosis filter storage tanks of this type are disclosed, by way of example, in U.S. Pat. Nos. 7,726,511 and 7,763,171, which are used in reverse osmosis filter systems disclosed in U.S. Pat. No. 7,601,256 and U.S. Pat. No. 9,731,984, the disclosures of which are incorporated herein in their entirety by reference. Also incorporated herein by reference are U.S. patent application Ser. No. 15/647,670 and U.S. Provisional Patent Application No. 62/514,561.

Currently there is very strong competition between restaurants and coffee houses, as well as vendors of equipment therefor, to produce the best coffee possible. Currently, it is believed that the best coffee is produced using water with a total dissolved solid content of 150 parts per million. Frequently, tap water is substantially higher than that, and can easily run over twice that value or higher. Reverse osmosis filter systems grossly reduce the total dissolved solids content of the water, though tend to do so on a percentage basis, so that the total dissolved solids in the product water produced by a reverse osmosis filter will depend on the total dissolved solids in the raw water provided to the reverse osmosis filter. Accordingly, if the product water of a reverse osmosis filter is used in the making of such coffee, the amount of total dissolved solids which must be added back to the reverse osmosis product water will vary, dependent upon the characteristics of the water which was filtered by the reverse osmosis filter, which can vary with time, the extent of recent rain, etc. In that regard, remineralization filters are also known, but these are not the true solution to the problem, as the amount of remineralization of reverse osmosis product water that is needed is not known until that product water can be tested.

### BRIEF DESCRIPTION OF THE DRAWINGS

FIG. 1 is an illustration of a prior art reverse osmosis filter system generally in accordance with U.S. Pat. No. 7,601,256 within which the present invention may be incorporated.

FIG. 2 is an illustration of the top of a manifold assembly of a reverse osmosis filter system generally in accordance with FIG. 1 and incorporating an embodiment of the present invention.

FIG. 3 is an illustration of the top of a manifold assembly of a reverse osmosis filter system generally in accordance with FIG. 1 and incorporating another embodiment of the present invention.

### DETAILED DESCRIPTION OF THE PREFERRED EMBODIMENTS

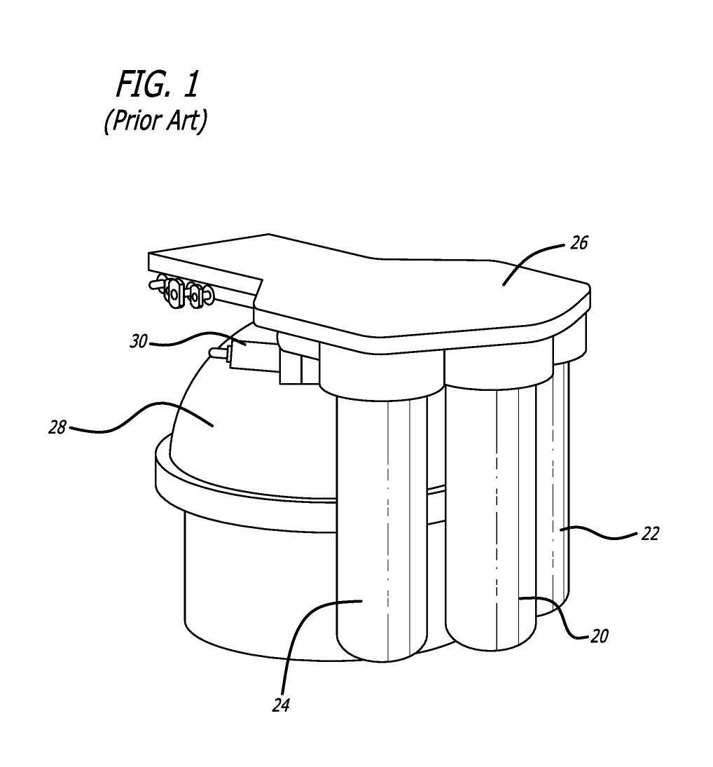

The present invention is a reverse osmosis filter system that will produce reverse osmosis product water with a readily controllable and adjustable total dissolved solids content, as may be desired for coffee making and the like. The system is fabricated around reverse osmosis filter systems preferably using squeeze water storage and dispensing of product water, such as that disclosed in U.S. Pat. No. 7,601,256 hereinbefore incorporated by reference. A Figure illustrating a system generally in accordance with the foregoing patent may be seen in FIG. 1. Visible in this Figure is the reverse osmosis filter itself 20, together with a pair of other filters 22 and 24, coupled to and supported from a manifold assembly 26, which itself is coupled to the product water storage tank 28. All these components of the system are generally in accordance with the '256 patent, which provides details of the various elements hereinbefore described. Also visible in FIG. 1 is a pressure regulator 30 which regulates the pressure of the water coming into the system, hereinafter referred to as the line pressure. The advantage of using such a pressure regulator is that it establishes a fixed operating pressure for the system, allowing maintenance of a fixed product water/waste water ratio and fixed product water dispensing rates, independent of pressure variations and fluctuations in the municipal water supply, and further limits the pressures the various components may be subjected to due to pressure variations, water hammer effects, etc.

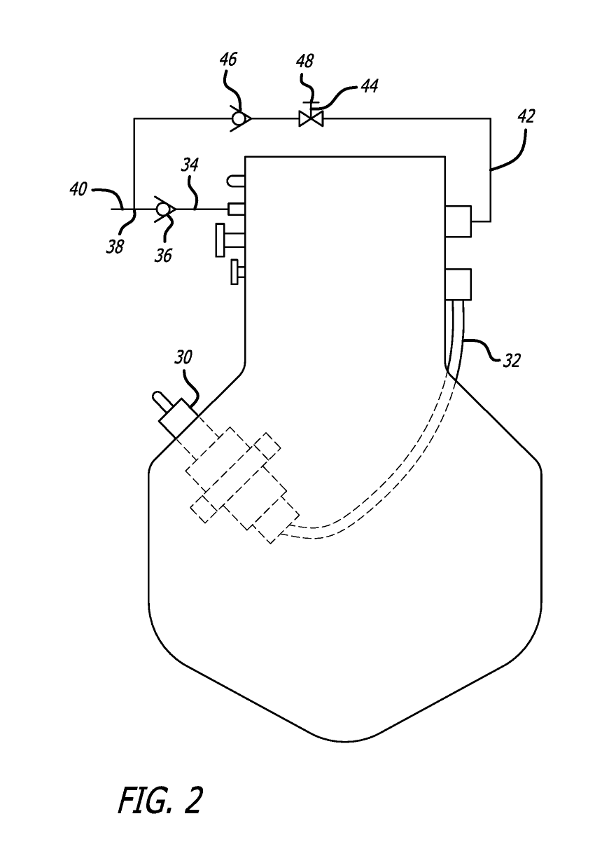

Now referring to FIG. 2, an illustration of the top of the manifold assembly 26 of FIG. 1 may be seen. As shown in that Figure, in this embodiment water from the water supply enters the system through the pressure regulator 30, with supply water at the regulated pressure entering the manifold assembly through line 32. That water then is provided through the manifold assembly to filter 22 (FIG. 1), then to reverse osmosis filter 20 and then part to the drain as waste water, and part through the reverse osmosis filter to the storage tank 28 (FIG. 1), at least when the system is producing product water. Product water, while being dispensed, will flow through line 34, check valve 36 and T-coupling 38 to final output line 40.

Line 42 is effectively coupled to the squeeze water region between the bladder and the wall of the storage tank 28, with line 42 having a needle valve 44 therein and a second check valve 46 before that flow is joined by T-coupling 38 with the product water flow through line 34, etc. for the final output when product water is being dispensed.

The system herein described operates as follows. During the production of product water, when the storage tank 28 is not full and product water is not being dispensed, the pressure in lines 34 and 40 will be approximately 50% of the regulated pressure in line 32, a result of the control valve used, namely a control valve in accordance with U.S. Pat. No. 6,110,360. At this time, the squeeze water in line 42 will be vented, though backflow through line 42 is prevented by the check valve 46. When the storage tank 28 is filled, line 34 will reach the full regulated line pressure. Still, the squeeze water in line 42 will be vented, though backflow through line 42 is still prevented by the check valve 46. Consequently, both during product water production and the quiescent state of the system when the storage tank 28 is full, there will be no flow in either lines 34 or 42. However, when the pressure in line 40 drops when a faucet or other appliance coupled thereto is opened, the control valve referred to and mounted below the manifold assembly in that area couples the line water in line 32 at the regulated pressure that has been provided through filter 22 to the reverse osmosis filter 20 directly from around the reverse osmosis filter element (membrane) to the region between the bladder in the storage tank and the storage tank wall, thereby providing squeeze water at the full regulated line pressure from line 32 to pressurize the product water for delivery through lines 34 and 40. At the same time, the same increase in squeeze water pressure from a vented condition to full regulated line pressure will cause a selectable and controllable flow through needle valve 44, check valve 46 and T-connection 38 to mix with the reverse osmosis product water that is being discharged through line 34.

Accordingly, during dispensing, and only during dispensing, a controlled proportional flow of line water which has not passed through the reverse osmosis filter element will be mixed with reverse osmosis product water to increase the total dissolved solids to the desired level. In that regard, the total dissolved solids in the water being dispensed through line 40 is easily measured by measuring its electrical conductivity, with the amount of totally dissolved solids in line 40 being readily adjustable by adjustment of the needle 48 of the needle valve 44. Note that the adjustment is not adjusting the product water produced by the basic reverse osmosis system, but rather is adjusting the amount of raw or waste water that is mixed with the reverse osmosis filter system product water. Consequently, in making this adjustment, one need not make an adjustment and then wait for the production of product water at the new setting to see whether the new setting is proper, but rather one can adjust the setting and then make a measurement substantially immediately to verify the new setting is proper. Since the measurement of total dissolved solids is such an easy measurement and the effects of an adjustment can be determined substantially immediately, such adjustments may be made as frequently as desired without disturbing the operation of the system.

Note that the foregoing cannot be achieved with air captive systems described herein in the prior art section, as the only available source of water that hasn't passed through the reverse osmosis filter will be at line pressure, at a regulated pressure if a pressure regulator is used, or some fraction of one of these pressures. In any case, this would create an adjustable flow rate of water that hasn't passed through the reverse osmosis filter, but still resulting in a flow rate that would not respond to the diminishing product water dispensing rate as the quantity of stored product water in the storage tank is reduced and the pressure of the captive air or gas similarly reduces. Thus the total dissolved solids in the water that would ultimately be dispensed by such an air captive system could easily vary by a ratio of 1 to 2 during dispensing from a nearly full product water storage tank to a nearly empty product water storage tank, defeating the true purpose of the invention.

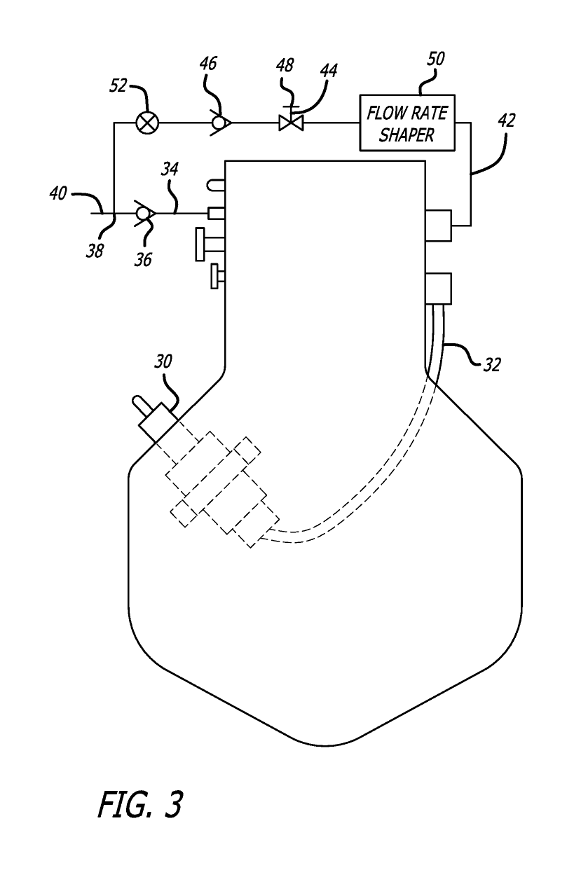

In some embodiments, the dispensing rate of the water with selectable total dissolved solids dispense through line 40 will vary because of some back pressure on line 40, such as might occur when dispensing not to a faucet that is held fully open, but a faucet that is only partially open. Another example is when multiple reverse osmosis filters are operated in parallel to provide an enhanced filtering capability as well as an enhanced dispensing capability, but only a fraction of that enhanced dispensing capability is being used at a particular time. In such situations, it will be desired that during dispensing, the flow rate ratio between the reverse osmosis filtered water in line 34 and the un-reverse osmosis filtered water in line 42 remain fixed or constant, at least within reasonable limits, over the range of overall flow rates in line 40. To this end, a flow rate shaper 50 is added to the structure of FIG. 2, as may be seen in FIG. 3. In particular, the flow through line 34 during dispensing would be some combination of laminar flow, turbulent flow and flow through an orifice, which flow characteristics can be duplicated in the flow rate shaper 50, which may have multiple passages therein for that purpose. In that regard, while tracking the transition from laminar to turbulent flow in the reverse osmosis filtered water may be difficult to maintain both adjustability in mixing proportions and a fixed or constant mixing ratio with variable flow rates within the desired tolerances, one could simply design the flow paths so that the primary pressure drop when dispensing is due to laminar flow. This way, the flow rates in lines 34 and 42 will both be proportional to the pressure drop therein, which pressures are equal, minus the back pressure encountered, and therefore will remain constant within desired limits through a wide range of mixing ratios. Also, in the embodiment of FIG. 3, a shutoff valve 52 is provided so that the system may be used to selectively dispense either water with a selectable total dissolved solids, or simply reverse osmosis filtered water that generally will have a total dissolved solids content substantially less than that which is preferable for coffee, etc. Preferably valve 52 is a ball valve, though other types of valves may be used as desired.

In the foregoing description, a specific squeeze water product water accumulator and product water dispensing system was used, as was a specific control valve. While a squeeze water type storage and dispensing system or alternate substantially constant dispensing pressure system needs to be used and preferably the pressure regulator hereinbefore referred to should be used, other control valves and/or other reverse osmosis filter systems having different structures may be used, as desired. Of particular importance is that the squeeze water, or water not reverse osmosis filtered, but at a pressure responsive to squeeze water pressure, be used to eject a controlled amount of un-reverse osmosis filtered water, together with reverse osmosis product water, but only upon the dispensing of such product water.

In the embodiments disclosed herein, the squeeze water is first routed past the reverse osmosis membrane and then to squeeze the bladder in the storage tank 28 (FIG. 1), though alternatively water directly from the municipal water supply could be used for squeeze water, and for mixing with the reverse osmosis filtered water responsive to the squeeze water pressure, either by using such squeeze water or simply being responsive to squeeze water pressure.

Also the embodiments disclosed herein are purely mechanical, or hydro-mechanical not requiring electricity for operation, simplifying installation and eliminating any electrical shock risk. However clearly the present invention is also directly applicable to reverse osmosis filter systems that require electricity for operation, such as for operating pumps, solenoid operated valves, etc. As one example, the squeeze water pressure itself may be provided by a pump that is part of the reverse osmosis system.

Thus while preferred embodiments of the present invention has been disclosed and described herein for purposes of illustration and not for purposes of limitation, it will be understood by those skilled in the art that various changes in form and detail may be made therein without departing from the spirit and scope of the invention.

What is claimed is:

1. A method of providing water with a selectable total dissolved solids content comprising:
reverse osmosis filtering of water having a dissolved solids content exceeding the selectable total dissolved solids content to provide filtered water having a dissolved solids content less than the selectable total dissolved solids content;
mixing water having a dissolved solids content exceeding the selectable total dissolved solids content with the filtered water in a ratio to provide water with the selectable total dissolved solids content.

2. The method of claim 1 wherein the water having a dissolved solids content exceeding the selectable total dissolved solids content is supplied by a municipal water supply.

3. The method of claim 1 wherein the reverse osmosis filtering is done with a reverse osmosis filter using squeeze water to pressurize filtered water in a storage tank for causing the mixing of water having a dissolved solids content exceeding the first predetermined total dissolved solids with the filtered water in a ratio to provide and dispense water having the selectable total dissolved solids content.

4. The method of claim 3 wherein the water having a dissolved solids content exceeding the selectable total dissolved solids content is supplied by a municipal water supply, and wherein the squeeze water is coupled to the municipal water supply during dispensing of the water having the selectable total dissolved solids content.

5. The method of claim 4 wherein the squeeze water is coupled to the municipal water supply during dispensing of the water having the selectable total dissolved solids content by coupling a municipal water supply side of a reverse osmosis membrane to provide the squeeze water and to flush the municipal water supply side of the reverse osmosis membrane.

6. The method of claim 5 wherein the ratio for mixing water having a dissolved solids content exceeding the selectable total dissolved solids content with the filtered water to provide the water with the selectable total dissolved solids content is manually adjustable.

7. The method of claim 5 wherein the flow rate of the water having a dissolved solids content exceeding the selectable total dissolved solids content is shaped to match the flow rate of the filtered water to mix in a constant ratio over a range of flow rates during dispensing of the water having the selectable total dissolved solids content.

8. The method of claim 7 wherein the method is practiced using a self-contained reverse osmosis filter system that operates responsive to changes in the pressure of the water with the selectable total dissolved solids content at an outlet of the reverse osmosis filter system.

9. The method of claim 8 wherein the self-contained reverse osmosis filter system includes a pressure regulator to regulate the pressure of the water having a dissolved solids content exceeding the selectable total dissolved solids content received from the municipal water supply.

10. The method of claim 9 wherein the self-contained reverse osmosis filter system is a mechanical system and is operative without electricity.

11. The method of claim 1 wherein the ratio for mixing water having a dissolved solids content exceeding the selectable total dissolved solids content with the filtered water to provide the water with the selectable total dissolved solids content is manually adjustable.

12. The method of claim 1 wherein the flow rate of the water having a dissolved solids content exceeding the selectable total dissolved solids content is shaped to match the flow rate of the filtered water to mix in a constant ratio over a range of flow rates during dispensing of the water having the selectable total dissolved solids content.

13. The method of claim 1 wherein the method is practiced using at least one self-contained reverse osmosis filter system that operates responsive to changes in the pressure of the water with the selectable total dissolved solids content at an outlet of the reverse osmosis filter system.

14. The method of claim 13 wherein the self-contained reverse osmosis filter system includes a pressure regulator to regulate the pressure of the water having a dissolved solids content exceeding the selectable total dissolved solids content received from the municipal water supply.

15. The method of claim 13 wherein the self-contained reverse osmosis filter system is a mechanical system and is operative without electricity.

16. Apparatus for receiving water having a first dissolved solids content exceeding a selectable total dissolved solids content and providing water with the selectable total dissolved solids content at an apparatus output comprising:
a reverse osmosis water filtering system for receiving the water of a first dissolved solids content exceeding the selectable total dissolved solids and providing at a reverse osmosis water filtering system output, filtered water having a second dissolved solids content less than the selectable total dissolved solids content, the reverse osmosis water filtering system having a squeeze water system for dispensing from the reverse osmosis water filtering system output;
a second line coupled between a squeeze water line of the reverse osmosis water filtering system and the apparatus output, the squeeze water line having squeeze water pressure therein and;
a flow rate adjuster in the second line;
whereby during dispensing, squeeze water pressure will cause the reverse osmosis water filtering system to dispense filtered water having a second dissolved solids content less than the selectable total dissolved solids content, together with squeeze water, which when mixed in a proportion set by the flow rate adjuster, provide the filtered water having the selectable total dissolved solids content.

17. The apparatus of claim 16 further comprising at least one check valve to prevent backflow from the apparatus output to the second line or to the reverse osmosis water filtering system.

18. The apparatus of claim 17 wherein the at least one check valve comprises a first check valve in the second line and a second check valve in the reverse osmosis water filtering system output.

19. The apparatus of claim 18 further comprising an on/off valve in the second line, whereby the flow of squeeze water through the second line may be shut off to selectively dispense the filtered water having a second dissolved solids content less than the selectable total dissolved solids content.

20. The apparatus of claim 16 wherein the flow rate adjuster is manually operable.

21. The apparatus of claim 16 wherein the reverse osmosis filtering system includes a pressure regulator regulating pressures therein.

22. The apparatus of claim 21 further comprising a flow rate shaper in the second line for shaping the flow rate of the squeeze water in the second line to match the flow rate of the filtered water having a second dissolved solids content less than the selectable total dissolved solids content over a range of flow rates of the filtered water having a second dissolved solids content less than the selectable total dissolved solids content.

23. The apparatus of claim 22 wherein the on/off valve is a ball valve.

24. The apparatus of claim 16 wherein the filtered water having a second dissolved solids content less than the selectable total dissolved solids content and squeeze water are mixed and dispensed from a common apparatus output.

25. The apparatus of claim 16 wherein the reverse osmosis filter system is configured to couple to a municipal water supply, and wherein the squeeze water is coupled to the municipal water supply during dispensing of the water having the selectable total dissolved solids content.

26. The apparatus of claim 25 wherein the reverse osmosis filter system couples the squeeze water to the municipal water supply during dispensing of the water having the selectable total dissolved solids content by coupling a municipal water supply side of a reverse osmosis membrane to provide the squeeze water and to flush a municipal water supply side of a reverse osmosis membrane.

27. The apparatus of claim 16 wherein the reverse osmosis filter system is a self-contained reverse osmosis filter system that operates responsive to changes in the pressure of the water with the selectable total dissolved solids content at an outlet of the reverse osmosis filter system.

28. The apparatus of claim 27 wherein the self-contained reverse osmosis filter system is a mechanical system, thereby being operative without electricity.
